(19) United States
(12) Patent Application Publication
(10) Pub. No.: US 2008/0221919 A1
(43) Pub. Date: Sep. 11, 2008

(54) MEDICAL CLINIC FORMED BY MODULAR TRANSPORTABLE COMPONENTS

(76) Inventor: James Wilson Cates, Allons, TN (US)

Correspondence Address: SUGHRUE MION, PLLC, 2100 PENNSYLVANIA AVENUE, N.W., SUITE 800, WASHINGTON, DC, 20037, US

(21) Appl. No.: 11/683,315

(22) Filed: Mar. 7, 2007

(51) Int. Cl. G06Q 50/00; E04G 21/00

(52) U.S. Cl. 705/2; 52/745.2

(57) ABSTRACT

A medical clinic system, including: an unattached medical clinic formed by modular transportable components, wherein the transportable modules are partially constructed portions of a building; a registration module wherein a patient registers for an appointment, and wherein an appointment type request is generated and transmitted to a server; a triaging module wherein a patient is triaged, and wherein a patient record is generated and transmitted to the server; an exam room having at least one computer terminal with access to the server; a plurality of medical instruments, wherein the plurality of medical instruments are connected to the server, a digital radiology suite; and a pharmacy.

### BACKGROUND OF THE INVENTION

1. Field of the Invention

Methods and systems consistent with the present invention relate to a method and system for providing affordable medical care, and more particularly, to a method and system of providing affordable medical care through medical clinics constructed of modular transportable building components, that are easily accessible by a transportation based society. Consistent with the invention, the costs associated with the facilities and structures are reduced, and the medical clinics may be staffed with board certified doctors, with a high level of expertise and training, consequently providing high quality healthcare.

A clinic may incorporate evidence based medicine as a standard. Protocols will be developed and updated using the current evidence based medicine to encourage doctors to practice at the highest standards. The standards will be continuously updated through communication technology which links all of the medical clinics.

2. Description of Related Art

In the United States, the cost of medical care for the average American is $7,393 in 2007, and may rise as high as $10,111 by 2010. Traditionally, Americans have sought out primary care providers at private practices. Traditional methods of dispensing healthcare are expensive. Scheduling appointments with busy primary care physicians may be difficult, which may lead to extended periods of time from when a patient becomes sick to when the patient begins treatment. This in turn may exacerbate the illness, and increase the cost, both in price of treatment and in time spent with a doctor.

One response to the rising cost of healthcare has been staffing medical clinics with less expensive personnel. That is, replacing the doctors from which patients have traditionally received healthcare, with registered nurses (RN), nurse practitioners (NP), and physicians assistants (PA). Costs have also been reduced by decreasing the amount of time a patient spends with a healthcare provider. Finally, some clinic facilities have been reduced to merely an examination room and a medicine cabinet.

However, using the foregoing techniques to reduce costs has been subject to increased resistance by practicing physicians, and organizations of physicians such as the American Medical Association (AMA) and the American Academy of Pediatrics (AAP). One reason for the resistance is due to a phenomena called “Fragmentation of Care”. “Fragmentation of Care” may occur when a patient receives medical care from different healthcare providers that do not communicate with each other. If a patient receives care at a first medical clinic, and then receives care for the same (or different) ailment at a second medical clinic, the healthcare providers will not communicate about the patient if there is no established communication system. Patient records may not be transferred or available to other locations. This may lead to an incomplete account of a patient's medical history, redundancy of tests and treatments, etc.

The problem of “Fragmentation of Care” may be especially apparent when the patient is a child. There are many health related issues that may develop during childhood, and they can be more easily identified by a doctor that is familiar with a child's medical history. Both the AMA and the AAP have recommended against treating children at reduced cost clinics that cannot provide the same quality and continuity of care that is delivered by traditional medical care.

There are benefits to comprehensive, coordinated and continuous care of a patient. Clinics which reduce the cost of individual visits by reducing quality and the range of services, can create “Fragmentation of Care” by forcing patients to visit different service providers to receive the full range of services necessary for treatment.

A problem with both traditional healthcare delivery mechanisms and reduced cost clinic as described above, is that they are not designed for a transportation society. “Transportation society” is used herein as a generalization to describe the fact that many American's own cars or some mode of transportation, commute long distances to work, and spend considerable amounts of time driving on large public highways. Medical clinics are not necessarily set up for convenient access by today's transportation society.

For the foregoing reasons, there is a need for a medical clinic where patients may receive the quality and continuity of care associated with the traditional delivery of healthcare, but with greater convenience and lower cost.

### SUMMARY OF THE INVENTION

What is claimed is a method of providing affordable medical care in an unattached medical clinic, comprising: selecting a first location to construct the unattached medical clinic, wherein the location is in close geographic proximity to a transportation thoroughfare; assembling, at the first location, the unattached medical clinic formed by modular transportable components, wherein the modular transportable components are pre-constructed portions of the medical clinic; and providing medical care in the unattached medical clinic.

According to an aspect of the present invention, the method comprises: electronically registering a patient upon entry to the unattached medical clinic; taking a history of a patient; evaluating the patient via an interface instrument; examining the patient based on an evaluating result, a registering result and the history of the patient; and treating the patient based on the examining results.

According to another aspect of the present invention the patient is referred to one of the patient's primary care physician and to a hospital.

According to another aspect of the present invention the modular components are built at a second location different than the first location chosen for the unattached clinic.

According to another aspect of the present invention the unattached medical clinic is staffed with medical technicians, non-medical technicians, and healthcare providers.

According to another aspect of the present invention an ownership interest is divided among one or more employees.

According to another aspect of the present invention indicators are provided, wherein the indicators indicate the location of the unattached medical clinic.

According to another exemplary embodiment of the present invention, a medical clinic system is provided, comprising: an unattached medical clinic formed by modular transportable components, wherein the transportable modules are partially constructed portions of a building; a registration module wherein a patient registers for an appointment, and wherein an appointment type request is generated and transmitted to a server; a triaging module wherein a patient is triaged, and wherein a patient record is generated and transmitted to the server; an exam room having at least one computer terminal with access to the server; a plurality of medical instruments, wherein the plurality of medical instruments are connected to the server, a digital radiology suite; and a pharmacy.

According to another aspect of the present invention, a patient terminal connected to the server wherein the patient terminal can receive the patient data.

A medical clinic system, comprising: a plurality of unattached medical clinics formed by modular transportable components, wherein the modular transportable components are partially constructed portions of a building; a registration module wherein a patient registers for an appointment, and wherein an appointment type request is generated and transmitted to a server; a triaging module wherein a patient is triaged, and wherein a patient record is generated and transmitted to the server; an exam room having at least one computer terminal with access to the server; a reference library with a plurality of medical instruments, wherein the plurality of medical instruments are connected to the server, a digital radiology suite; and a pharmacy; wherein the plurality of unattached medical clinics are connectable to the server.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings, of which:

FIG. 1 is a schematic of an unattached medical clinic constructed from transportable modular components, according to an exemplary embodiment of the present invention;

FIG. 2 is a schematic of an unattached medical clinic according to an exemplary embodiment of the present invention;

FIG. 3 is a flow chart describing the construction of a medical clinic according to an exemplary embodiment of the present invention;

FIG. 4 is a flow chart describing the process of a patient visit to a medical clinic, according to an exemplary embodiment of the present invention; and

FIG. 5 is a medical clinic system according to an exemplary embodiment of the present invention;

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

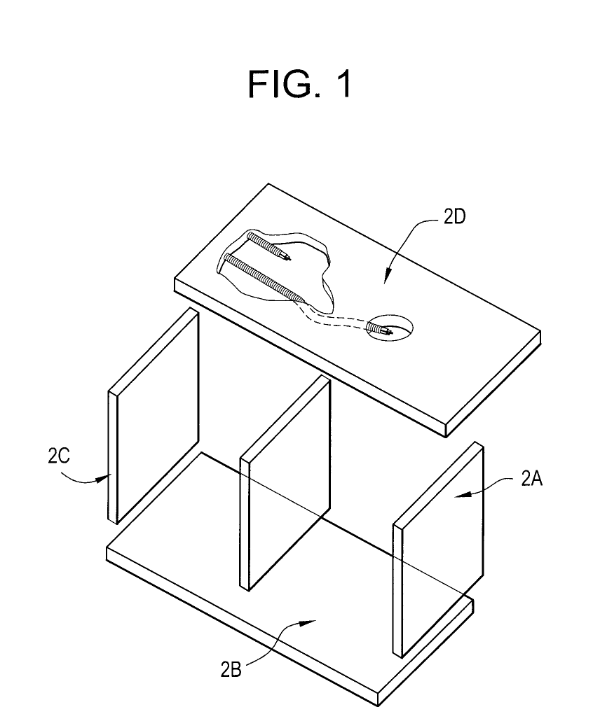

FIG. 1 illustrates transportable modular components, constructed for an unattached medical clinic, according to an exemplary embodiment of the present invention. Each of the transportable modular components 2A-2D is prefabricated at a location different than the location of the unattached medical clinic, and transported to the location of the clinic. The transportable modular components are fabricated such that they may be quickly assembled. Modular components consistent with the present invention, but which the invention is not limited to, are fabricated by, for example, Comark Construction, Inc., in Texas, using a form of modular construction where a floor plan is divided into smaller sections or modules which are constructed separately in a factory, and then assembled at the location of the clinic. According to an exemplary embodiment, the transportable modular components 2A-2D are factory produced according to a standard design so multiple clinics may be rapidly assembled.

Each of transportable modular components 2A-D may also be pre-wired as part of the fabrication process, in order to support the various digital technology (e.g. digital X-Ray) that will be available in the unattached medical clinic 1.

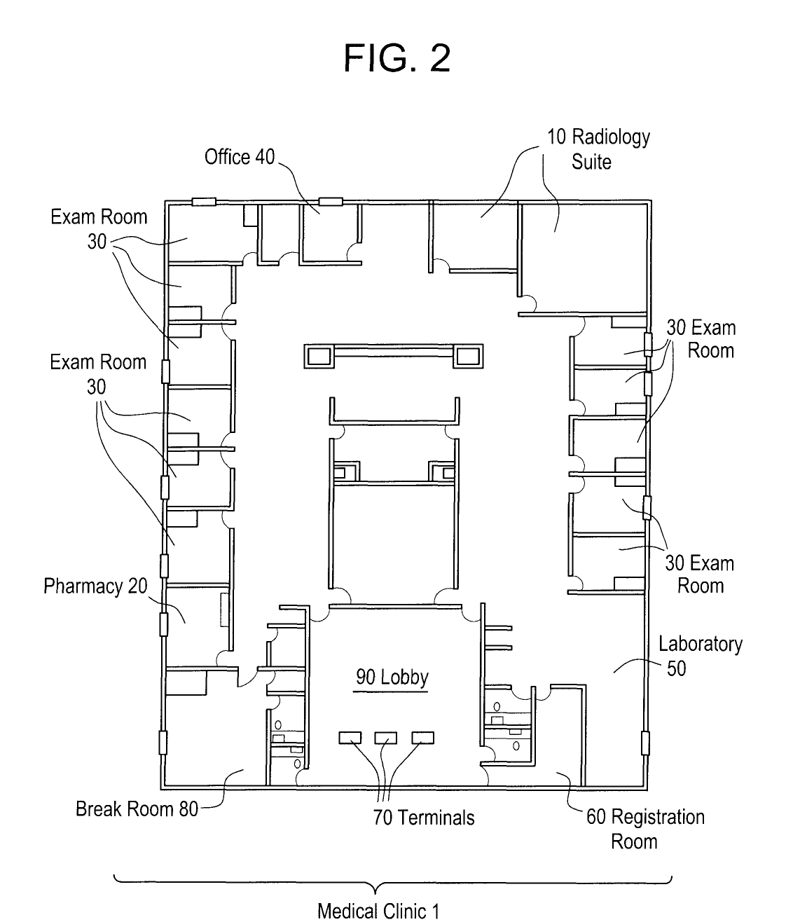

As shown in FIG. 2, according to an exemplary embodiment, the digital technology includes, as shown in FIG. 2, a registration room 60, a digital radiology suite 10, a laboratory 50, a lobby 90, computer terminals 70 used by doctors, for instance in offices 40, and used by patients, nurses, and administrative staff to register, for example in the lobby 90, access medical records, order tests, etc., and a break room 80. Pre-wiring could be included to support the digital technology. The terminals may be personal computers or a handheld device, for instance, in the case of registering.

By prefabricating the transportable modular components and pre-wiring the components to support the digital technology used in the medical clinic, the length of time from when a location is chosen to when the unattached medical clinic 1 is operable, may be reduced. For instance, a medical clinic constructed from pre-wired transportable modular components 2A-2D, as shown in FIG. 1, may be constructed in no more than two weeks, complete with the registration room 60, the digital radiology suite 10, a pharmacy 20, offices 40, an exam room 30, and the laboratory 50, as shown in FIG. 2, and open for business within four months of choosing a location.

The components and services provided in the unattached medical clinic 1 consistent with an exemplary embodiment of the present invention will now be described with reference to FIG. 2. The unattached medical clinic 1 includes the on-site digital radiology suite 10, an on-site pharmacy 20, an examination room 30, offices 40, the laboratory 50, and a break room 80. According to one exemplary embodiment, the medical clinic 1 may also include the registration room 60.

The digital radiology suite 10 may include Digital X-ray, a Picture Archive Communication system (PACS), a Computer Tomography (CT) Scanner, Mammography, Ultrasound, a Magnetic Resonance Imaging (MRI) machine, and an Electroencephalogram (EEG). According to an exemplary embodiment of the present invention, off-site radiologists will be able to read x-rays via the PACS. Further, the digital radiology suite 10 will include the ability to make compact discs immediately after an x-ray.

The laboratory 50 may be staffed by a pathologist, a licensed laboratory supervisory working under the pathologist, and other board certified doctors. The laboratory may be equipped with Beckman Coulter instruments. The Laboratory Information system is interfaced with each instrument as well as a orders and results module interfaced with the Electronic Medical Record.

The on-site pharmacy 20 stocks generic medications that are necessary for the majority of diagnoses that the medical clinic is equipped to handle. The drugs may be bought in bulk and prescriptions are filled on-site. Narcotics, however, would not normally be dispensed from the pharmacy 20.

The examination room 30 is used to examine a patient. A physician examines the patient in the examination room 30, using evidence based medicine protocols, which is described later. The examination room 30 may contain a terminal 70, which a doctor can use to update patient records, and order drugs and laboratory tests.

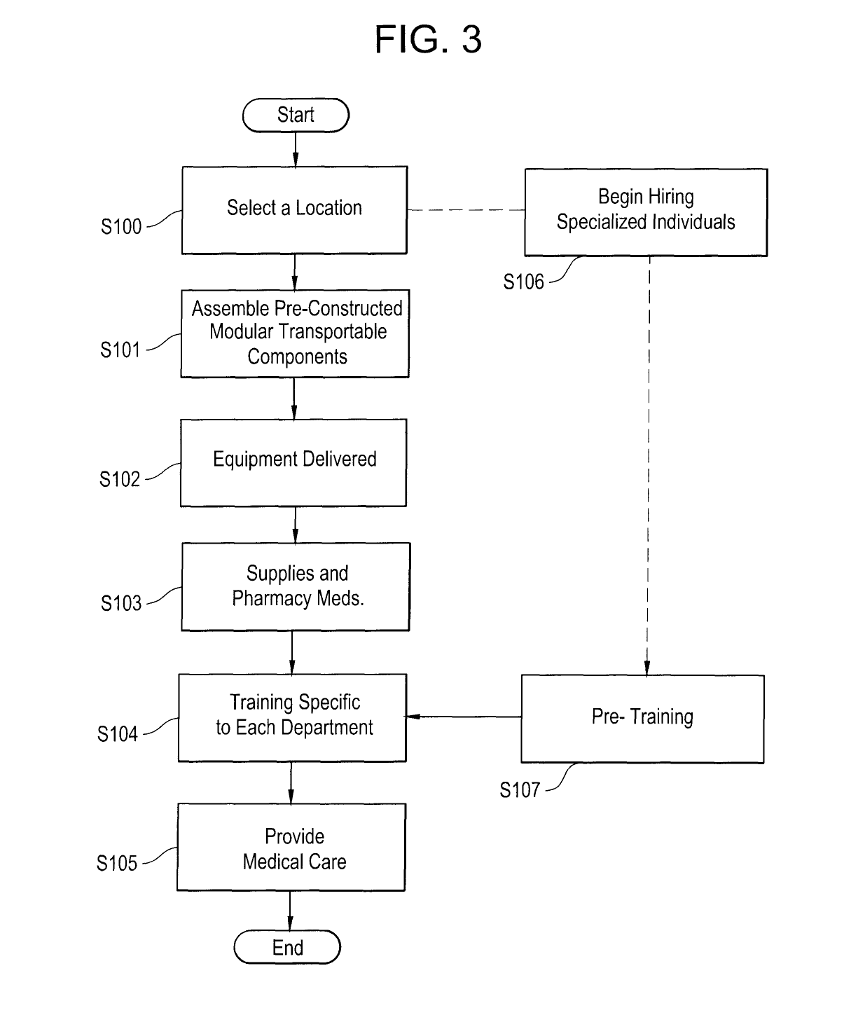

Reference will now be made to FIG. 3, which is a flow-chart illustrating the process of constructing and operating an unattached medical clinic according to an exemplary embodiment of the present invention.

Initially, a location is chosen to assemble the components of the unattached medical clinic (S100). The location of the medical clinic may be chosen to be close in geographic proximity to a high transportation thoroughfare, such as an interstate or a major highway. Close proximity to a high transportation thoroughfare allows the clinic to be visible and accessible to a large population which is trafficking on the thoroughfare. A high transportation thoroughfare would be for example a traffic count of greater than 35,000.

According to an exemplary embodiment, signs indicating the proximity of the medical clinic may be placed on the high transportation thoroughfare in order to increase visibility of the medical clinic. Therefore, when one is driving on a road, a medical clinic sign, similar to, for example, a sign used to indicate the proximity of food or fuel, will indicate the existence and/or proximity of a medical clinic.

Upon selecting a location for the medical clinic, the transportable modular components are assembled into a stand alone medical clinic (S101). As has already been stated, the transportable modular components are fabricated at a location other than the location chosen for the medical clinic. The transportable modular components are fabricated in order to be easily and quickly assembled into the medical clinic structure.

Once the transportable modular components are assembled, any necessary equipment is delivered and installed (S102). According to an exemplary embodiment the transportable modular components are pre-wired to support the equipment, such as information technology. Once the equipment is delivered and installed, medical supplies, such as pharmacy medication are delivered and stored (S103).

While the transportable modular components are being assembled into the medical clinic, and while the equipment is being installed and supplies provided, specialized personnel are hired (S106). Further, the hired personnel begin pre-training for working in the medical clinic. (S107).

In an exemplary embodiment, the medial clinic may be staffed with medical technicians, non-medical technicians, and healthcare providers. Medical technicians may include an x-ray technician, CRT technician, ultra-sound technician, and a pharmacist. Non-medical technicians may include administrative assistants and other administrative staff. Healthcare providers include board certified doctors, such as family practice doctors and specialists. The medical clinic is staffed with board certified doctors. The reason that the medical clinic may be staffed with board certified doctors, yet a low cost of providing healthcare is maintained, is because of the low cost of the physical building and use of technology. The staff receives specialized training with regard to the particular department in which they will work (S104).

Once the medical clinic has been staffed, medical care for patients may be provided (S105).

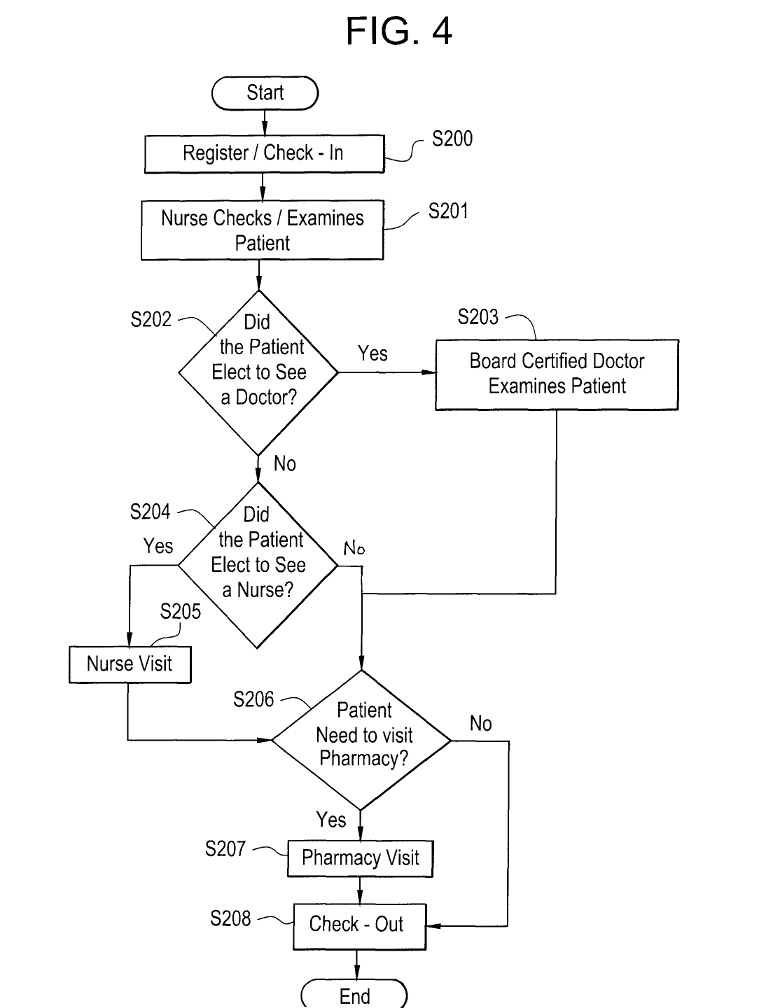

Reference will now be made to FIG. 4, which illustrates the process by which a patient registers into the clinic and receives healthcare, according to exemplary embodiments of the present invention.

In an exemplary embodiment, a patient checks-in by using a terminal (i.e. a handheld kiosk) located at the medical clinic (S200). During check-in, the patient provides information related to demographics, history, patient's medical complaints and purpose of visit, physician information/history, information related to drug history, and provides any relevant forms which may include forms where the patient states they have been provided any relevant information. The patient may further elect whether to visit with a doctor, or only visit with a nurse, or merely fill a prescription. A patient record may be generated or merely updated if one already exists.

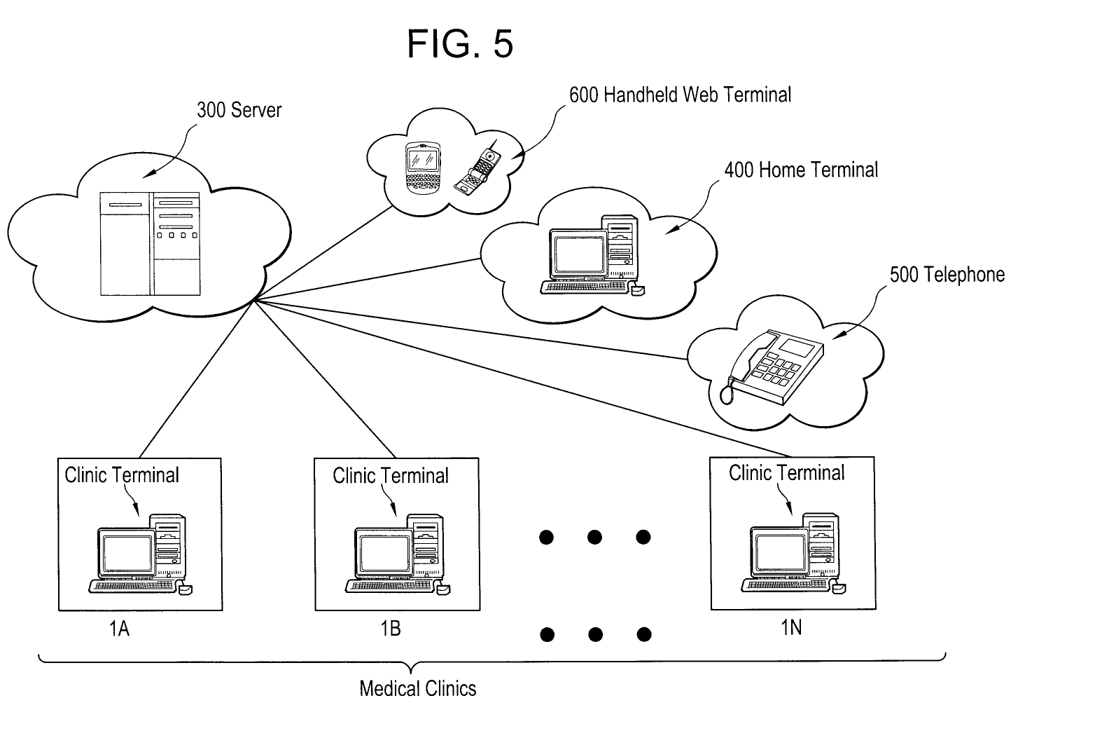

After checking-in, a nurse takes the patient's vitals, a history based on complaints and the information the patient entered when checking-in (S201). The nurse may also engage in a visual exam. All of the information gathered by the nurse is entered into a patient record, which resides on a central server 300, illustrated in FIG. 5, via a terminal.

If the patient elects to see a doctor during check-in (S202), a board certified doctor examines the patient (S203). While examining the patient, the doctor can access the patient's record via a terminal located in the examination room. By accessing the patient record, the doctor may view the patient's history, vitals, complaints, and any other information taken by the nurse and patient. The doctor can also order laboratory tests, x-rays, a CT scan, or drugs from the terminal while in the room with the patient.

Next, if the patient elects a nurse only visit (S204), then the patient does not see a doctor and only has a nurse visit (S205).

The standards of care applied by the doctors staffing the medical clinic are derived from evidenced based medicine, in order to allow patients to be treated for 50% of known ailments in a cost efficient amount of time. The standards are designed to follow research clinics such as Mayo Clinic's Institute for Clinical Systems Improvement (http://www.icsi.org/), and the National Quality Measures Clearinghouse guidelines (http://www.qualitymeasures.ahrq.gov/). For the most part evidenced based medicine comprises procedures and treatments that have been evaluated according criteria such as risk versus benefit, randomized control trials, and scientific literature.

During the examination, the doctor may examine the patient using equipment, such as a computed tomography scanner. Based on the examination results, the doctor may recommend further tests or prescribe medication.

After examining the patient, the doctor may refer the patient to a primary care physician that does not work at the medical clinic. Alternatively, the doctor may refer to the patient to a primary care physician working at the medical clinic.

After being examined and treated by the doctor or a nurse, the patient may then proceed to the on-site pharmacy and fill any prescriptions received during the visit (S207). All of the drugs at the pharmacy are generic. The average cost for filling a prescription is set at a low fixed cost, which is based on market averages, for example, no more than $5 in 2007.

After visiting with a doctor, filling any prescriptions, and receiving any required medication, the patient may check-out (S206 and S208). During check-out, the patient may go through a payment process. A fixed fee is charged for the entire cost of medical care. For visits that do not require a specialist (x-ray technician, MRI technician, etc.), a low fee of $35 might be charged. For visits that do require a specialist, a fee of $100 might be charged. Payment may be in the form of cash paid directly by the patient for the entire cost of the visit, a co-pay with a charge to a patient's insurance provider, or a voucher exchangeable for healthcare services.

The vouchers may be a multi-use voucher, for example, the voucher may be a gift card which may be used at any of the medical clinics. The gift cards may be provided by the medical clinic to the patient via organizations such as churches, assisted living centers, or other charitable organizations. The organizations may than pass the gift cards out to qualifying individuals, such as the elderly or indigents. The gift cards may be purchased by business owners for their employees. Business owners who cannot afford medical insurance for their employees, may find the gift cards as a way to defray healthcare costs for the business owner's employees.

After visiting the medical clinic, if the patient has further need of care, the patient can see a primary care provider outside of the medical clinic, or a primary care provider associated with the medical clinic.

A second exemplary embodiment is essentially the same as the first embodiment, except the patient checks-in (S200) at a terminal, over the Internet. The terminal may be located at the patient's home. When the patient checks-in over the Internet according to the second exemplary embodiment, the patient uses a secure website. The patient may be required to provide an identifier and password to access the secure website. The website is compliant with the Health Insurance Portability & Accountability Act (HIPAA). If it is the first time the patient has checked-in, a new patient record is generated and stored on a central server 300, shown in FIG. 5. If it is not the first time the patient has checked-in, the patient may be asked to provide identification information in order to retrieve the patient's record, which is then updated with the information the user provides during check-in.

A third exemplary embodiment is essentially the same as the first and second embodiments, except the patient checks-in using a telephone, a mobile phone, or another telecommunication device within or external to the medical clinic.

Reference will now be made to FIG. 5, which illustrates a medical clinic system according to an exemplary embodiment of the present invention.

As stated above, the medical clinic according to an exemplary embodiment of the present invention, is primarily digital, and uses technology to reduce the cost of healthcare, to help increase accuracy and efficiency, and reduce the time for the patient to receive quality treatment. Technology allows for patient's records to be continually built in real time. The physician's time is saved by being able to access medical information generated by the patient. The digital technology reduces the cost of healthcare by increasing accuracy and efficiency, and reducing the time it takes patents to receive healthcare. The use of technology includes a website which has been referred to, but not explained in detail. A central server 300 connects all medical clinics in the medical clinic system. The central server 300 hosts the website, and stores all of the patient records.

Upon registering for a visit to a medical clinic 1A-1N, a patient record is created if it is the patient's first visit. The record is stored at the central server 300, which is connected to all of the medical clinics in the medical clinic system. Nurses, doctors, and patients may access the patient records stored on the server via terminals located at the medical clinic, via the Internet, for example, using the patient terminal 400, via a telephone 500, or using a handheld web terminal (e.g., a smart phone) 600.

During a visit to the medical clinic, the patient record may be updated by a nurse while triaging the patient. Further, a doctor who is seeing the patient may also view and update the patient record, at the same time as the patient is being examined.

After visiting the medical clinic, a patient may access a website for the medical clinic in order to request services such as chart verifications and updates, prescription refills, communication with clinical staff and doctors, and viewing laboratory results. Healthcare providers may also access the website to view appointment requests, correspond with other healthcare providers and patients, and view laboratory results. As a security precaution, users may be required to provide an identifier and a password in order to access the website.

Software systems are commercially available which may accomplish some of the above mentioned operations when used on a terminal. As a non-limiting example, software such as Centricity®, Logician®, and Cardio Soft®, all available from General Electric Corporation, may be run on a terminal. Other software includes Kryptiq® for managing the transportation of patient records, and Galvanon® for patient registration and payment processing.

The medical clinic may offer health insurance, including an urgent care health plan. According to an exemplary embodiment, an individual health plan would require, for example, an initial minimum purchase of $500 and include a free physical. The plan would be renewable for a cost of $250, and would expire after three years of inactivity. A family plan, according to an exemplary embodiment, would require an initial minimum purchase of $1000 and include free physicals for immediate family members. The plan would be renewable for a predetermined cost, for example of $500, and would expire after three years of inactivity.

According to another exemplary embodiment of the present invention, an ownership interest in the medical clinic is divided among outside investors and the employees. The ownership interest of the employees may be less than 50% of the total ownership interest.

The above exemplary embodiments are not intended to be exhaustive. Instead, it would be appreciated by those skilled in the art that changes may be made to these exemplary embodiments without departing from the principles and spirit of the invention, the scope of which is defined by the claims and their equivalents.

What is claimed is:

1. A method, intended for use in providing affordable medical care in an unattached medical clinic, comprising:
selecting a first location to construct the unattached medical clinic, wherein the location is in close geographic proximity to a transportation thoroughfare;
assembling, at the first location, modular transportable components to produce the medical clinic, wherein the modular transportable components are pre-constructed portions of the medical clinic; and
providing medical care in the unattached medical clinic.

2. The method according to claim 1, further comprising:
electronically registering a patient after entry to the unattached medical clinic to provide a registering result;
taking a history of a patient;
evaluating the patient via an interface instrument to provide an evaluating result;
examining the patient based on the evaluating result, the registering result and the history of the patient, to provide an examining result; and
treating the patient based on the examining result.

3. The method according to claim 2, further comprising referring the patient to one of the patient's primary care physician and to a hospital, based on the examining result.

4. The method according to claim 2, further comprising providing a registration module, wherein the registering result is obtained from the registration module, based on inputs received over the Internet.

5. The method according to claim 4, wherein the registration module is located at a residence of the patient.

6. The method according to claim 2, further comprising providing a kiosk at the medical clinic, wherein the registering result is obtained based on inputs received at the kiosk.

7. The method according to claim 2, further comprising providing an electronic telephone registration module, and wherein the registering result is obtained based on telephone inputs received by the telephone registration module.

8. The method according to claim 1, wherein the modular transportable components are provided with wiring connections adapted for connection to at least one of a laboratory, an x-ray room, and a digital computed tomography scanner.

9. The method according to claim 1, further comprising building the modular components at a second location different than the first location.

10. The method according to claim 9, wherein all of the modular components are built at the second location.

11. The method according to claim 1, further comprising selling shares of ownership to individuals.

12. The method according to claim 1, further comprising spending a portion of generated revenue to provide care.

13. The method according to claim 12, wherein the care is provided to qualified individuals.

14. The method according to claim 13, wherein the qualified individuals are indigent persons.

15. The method according to claim 1, further comprising providing a right to medical service to an organization.

16. The method according to claim 15, wherein the right to medical service is a redeemable document.

17. The method according to claim 16, wherein the redeemable document is a voucher for healthcare at the medical clinic.

18. The method according to claim 16, wherein the voucher is a multi-use voucher.

19. The method according to claim 15, wherein the organization comprises one of a church, a business, and an assisted living center.

20. The method according to claim 1, wherein the evaluation result is determined according to an evidenced base medicine determination system.

21. The method according to claim 1, wherein procedures based on evidenced based medicine are available on a public database, wherein evidenced base medicine comprises procedures and treatments that have been evaluated according to at least one of risk versus benefit, randomized control trials, and scientific literature.

22. The method according to claim 1, further comprising providing indicators, wherein the indicators indicate the location of the unattached medical clinic.

23. The method according to claim 22, wherein the indicators are provided along the transportation thoroughfare.

24. The method according to claim 1, wherein the transportation thoroughfare is a high transportation thoroughfare.

25. The method according to claim 1, wherein a fixed fee is charged for entire cost of providing medical care.

26. The method according to claim 25, wherein the fixed fee charged for medical care that does not require treatment by a specialist is less than the fixed fee charged for medical that does require treatment by a specialist.

27. A medical clinic system, comprising:
an unattached medical clinic formed by modular transportable components, wherein the transportable modules are partially constructed portions of a building;
a registration module wherein a patient registers for an appointment, and wherein an appointment type request is generated and transmitted to a server;
a triaging module wherein a patient is triaged, and wherein a patient record is generated and transmitted to the server;
an exam room having at least one computer terminal with access to the server;
a plurality of medical instruments, wherein the plurality of medical instruments are connected to the server,
a digital radiology suite; and
a pharmacy.

28. The system of claim 27, wherein the pharmacy is stocked with a plurality of kinds of generic drugs.

29. The system of claim 27, wherein the digital radiology laboratory further comprises a picture archive communication system (PACS).

30. The system of claim 27, wherein the digital radiology laboratory comprises a computed tomography scanner (CT).

31. The system of claim 27, wherein the patient data comprises at least one of a patient record, an appointment request, a prescription information, and a physician correspondence.

32. The system of claim 27, wherein the server comprises means for a doctor to order laboratory tests, x-rays, CT's and medication.

33. The system of claim 27, wherein the server comprises means for a patient and a doctor to correspond via the doctor and patient terminal.

34. The system according to claim 27, wherein the registration module is a wireless kiosk.

35. The system according to claim 27, wherein the registration module is the patient terminal.

36. The system according to claim 27, further comprising a patient terminal connected to the server wherein the patient terminal can receive the patient data.

37. The system according to claim 27, further comprising a doctor terminal connected to the server wherein the doctor terminal can receive the patient data.

38. The system according to claim 27, wherein the registration module is a telephone.

39. The system according to claim 27, wherein the server is configured to allow a user to connect if the user has an identification and a password.

40. A medical clinic system, comprising:
an unattached medical clinic formed by modular transportable components, wherein the transportable modules are partially constructed portions of a building;
means for registering a patient for an appointment, and wherein an appointment type request is generated and transmitted to a server;
means for evaluating a patient, and wherein a patient record is generated and transmitted to the server;
means for accessing the server;
means for connecting a plurality of medical instruments to the server;
means for a digital radiology laboratory; and
means for storing and dispensing drugs.

41. A medical clinic system, comprising:
a plurality of unattached medical clinics formed by modular transportable components, wherein the modular transportable components are partially constructed portions of a building;
a registration module wherein a patient registers for an appointment, and wherein an appointment type request is generated and transmitted to a server;
a triaging module wherein a patient is triaged, and wherein a patient record is generated and transmitted to the server;
an exam room having at least one computer terminal with access to the server;
a reference library with a plurality of medical instruments, wherein the plurality of medical instruments are connected to the server,
a digital radiology suite; and
a pharmacy;
wherein the plurality of unattached medical clinics are connectable to the server.

42. The medical clinic system according to claim 41, wherein a first unattached medical clinic of the plurality of unattached medical clinics communicates with a second unattached medical clinic of the plurality of unattached medical clinics, via the server.

43. The medical clinic system according to claim 41, wherein the first unattached medical clinic of the plurality of unattached medical clinics transfers patient information with the second unattached medical clinic of the plurality of unattached medical clinics, via the server.
